(19) United States
(12) Patent Application Publication
(10) Pub. No.: US 2023/0410026 A1
(43) Pub. Date: Dec. 21, 2023

(54) PRODUCT TRANSPORTATION SYSTEM AND METHOD

(71) Applicant: Coretex Limited, Auckland (NZ)

(72) Inventors: Akinyemi Akinbowale KOYI, San Marcos, CA (US); James Philip ANDREW, Auckland (NZ); Travis Franklin ROSS, Lexington, SC (US); Steven Mark PERRIN, Alpine, CA (US)

(21) Appl. No.: 18/250,941

(22) PCT Filed: Oct. 27, 2021
(86) PCT No.: PCT/NZ2021/050190

§ 371 Date: Apr. 27, 2023

Related U.S. Application Data
(60) Provisional application No. 63/106,278, filed on Oct. 27, 2020.

(51) Int. Cl. G06Q 10/083; F25D 11/00; G01K 13/10

(52) U.S. Cl. CPC G06Q 10/083; F25D 11/003; G01K 13/10

(57) ABSTRACT

A method comprising obtaining a desired storage criterion for each of a plurality of products, the desired storage criteria including at least one condition, the at least one condition including a product temperature range; based on the product temperature range setting for each product at least one alert temperature range; calculating a current temperature of each of the plurality of products located in a compartment at a current time; calculating future temperatures of each of the plurality of products at a plurality of future times based on the current temperatures and expected changes between the current time and the plurality of future times; and for each of the plurality of products raising an alert if the current or calculated future temperature exceeds the product temperature range for that product.

### FIELD

This invention relates to a product transportation system and method.

### BACKGROUND

Temperature of perishable products during storage and transport has a significant impact on the shelf or usable life of the products. The shelf or usable life of a perishable product is the time before the products are considered unsuitable for sale, use, or consumption. Control and monitoring of products during transportation and delivery services is a concern for all parties. All parties of the supply and distribution chain are faced with the difficulty to assure products are safely and properly stored and transported at the right temperature. Typically, this relies on the transportation and delivery services to ensure that the products are stored and delivered in the appropriate temperature conditions. It would be desirable to provide a system and method to ensure that products are transported at the correct temperatures.

### SUMMARY

According to one example there is provided a method comprising:
obtaining a desired storage criterion for each of a plurality of products, the desired storage criteria including at least one condition, the at least one condition including a product temperature range;
based on the product temperature range setting for each product at least one alert temperature range;
calculating a current temperature of each of the plurality of products located in a compartment at a current time, the compartment including at least one door;
calculating future temperatures of each of the plurality of products at a plurality of future times based on the current temperatures and expected changes between the current time and the plurality of future times, the expected changes including calculating a number of door opening events before each future time.

Preferably the compartment may be being transported between locations and the method includes receiving route information and wherein the number of door opening events may be based on the route information.

Preferably a factor in calculating the future temperatures includes considering the time between drop off locations on the route.

Preferably calculating time between drop off locations includes considering traffic conditions and the method includes receiving traffic condition information.

Preferably the current temperature may be calculated based on information from at least one hardware temperature probe.

Alternatively the current temperature may be calculated based on information from at least one virtual temperature probes.

Preferably the compartment may be a refrigerated unit.

Preferably the refrigerated unit may be a reefer.

Preferably the refrigerated unit has a refrigeration unit and wherein the current temperature may be calculated based on information from at least one refrigeration unit sensor.

Preferably one of the at least one refrigeration unit sensor may be a return air sensor.

Preferably the current temperature may be further calculated based on sensor information from an environment the compartment may be located in.

Preferably the sensor information on the environment the compartment may be located in, includes environment temperature.

Preferably further comprising for each of the plurality of products raising an alert if the current or calculated future temperature exceeds the product temperature range for that product.

Preferably raising an alert includes raising an alert to a driver of a vehicle transporting the compartment.

Preferably raising an alert includes raising an alert with at least one of a shipper, a distributor, and a receiver of at least one of the plurality of products.

According to a further example there is provided a product storage criterion system comprising:
one or more processors;
memory associated with the one or more processors storing instructions to be executed by the processor; and
at least one networking device;
wherein the one or more processors is programmed to:
obtaining a desired storage criterion for each of a plurality of products, the desired storage criteria including at least one condition, the at least one condition including a product temperature range;
based on the product temperature range setting for each product at least one alert temperature range;
calculate a current temperature of each of the plurality of products located in a compartment at a current time, the compartment including at least one door;
calculate future temperatures of each of the plurality of products at a plurality of future times based on the current temperatures and expected changes between the current time and the plurality of future times, the expected changes including calculating a number of door opening events before each future time.

Preferably the compartment may be being transported between locations and the system includes receiving route information via the networking device and wherein the number of door opening events may be based on the route information.

Preferably a factor in calculating the future temperatures includes considering the time between drop off locations on the route.

Preferably calculating time between drop off locations includes considering traffic conditions and the system includes receiving traffic condition information via the networking device.

Preferably the system includes at least one hardware temperature probe and the current temperature may be calculated by the one or more processors based on information from the at least one hardware temperature probe.

Preferably the one or more processors may be programmed to emulate at least one virtual temperature probe and the current temperature may be calculated by the one or more processors based on information from the at least one virtual temperature probe.

Preferably the compartment may be a refrigerated unit.

Preferably the refrigerated unit may be a reefer.

Preferably wherein the refrigerated unit has a refrigeration unit including at least one refrigeration unit sensor in communication with the one or more processors and wherein the current temperature may be calculated by the one or more processors based on information from at least one refrigeration unit sensor.

Preferably one of the at least one refrigeration unit sensor may be a return air sensor.

Preferably the current temperature may be further calculated by the one or more processors based on sensor information received by the processor from an environment the compartment may be located in.

Preferably the sensor information on the environment the compartment may be located in, includes environment temperature.

Preferably the one or more processors further programmed to for each of the plurality of products raising an alert if the current or calculated future temperature exceeds the product temperature range for that product.

Preferably raising an alert includes raising an alert to a driver of a vehicle transporting the compartment.

Preferably raising an alert includes raising an alert with at least one of a shipper, a distributor, and a receiver of at least one of the plurality of products.

According to a still further example there is provided a method comprising:
obtaining a desired storage criterion for each of a plurality of products, the desired storage criteria including at least one condition, the at least one condition including a product temperature range;
based on the product temperature range setting for each product at least one alert temperature;
calculating a current temperature of each of the plurality of products located in a compartment at a current time, the compartment may be being transported between locations, the compartment including at least one door;
storing the current time and the current temperatures of each of the plurality of products in the compartment;
obtaining a drop off location for each of the plurality of products;
calculating a drop off time for each drop off location;
calculating future temperatures of the plurality of products at a plurality of future times up to including the drop off time of the products based on the current temperatures and expected changes between the current time and the plurality of future times, the expected changes including calculating a number of door opening events before each future time; and
receiving route information;
rearranging the route to minimise loss based on the plurality of products for which the current or future temperatures exceed the product temperature range.

Preferably the current temperature may be calculated based on information from at least one hardware temperature probe.

Preferably the current temperature may be calculated based on information from at least one virtual temperature probe.

Preferably the compartment may be a refrigerated unit.

Preferably the refrigerated unit may be a reefer.

Preferably the refrigerated unit has a refrigeration unit and wherein the current temperature may be calculated based on information from at least one refrigeration unit sensor.

Preferably one of the at least one refrigeration unit sensor may be a return air sensor.

Preferably the current temperature may be further calculated based on sensor information from an environment the compartment may be located in.

Preferably the sensor information on the environment the compartment may be located in includes environment temperature.

Preferably the number of door opening events may be calculated based on the route information.

Preferably a factor in calculating the future temperatures includes considering the time between drop off locations on the route.

Preferably including receiving traffic condition information and wherein calculating time between drop off locations includes considering traffic conditions.

Preferably including receiving information on the value of each of the plurality of products located in a compartment and minimising loss based on the plurality of products for which the current or future temperatures exceed the product temperature range minimising the loss based on minimising total value of the loss.

Preferably including raising an alert when current or future temperatures exceed the product temperature range with at least one of a shipper, a distributor, and a receiver of at least one of the plurality of products.

According to another example there is provided a product storage criterion system comprising:
one or more processors;
memory associated with the one or more processors storing instructions to be executed by the processor; and
at least one networking device;
wherein the processor is programmed to:
obtaining a desired storage criterion for each of a plurality of products, the desired storage criteria including at least one condition, the at least one condition including a product temperature range;
based on the product temperature range setting for each product at least one alert temperature range;
calculate a current temperature of each of the plurality of products located in a compartment at a current time, the compartment is being transported between locations, the compartment including at least one door;
storing the current time and the current temperatures of each of the plurality of products in the compartment;
obtaining a drop off location for each of the plurality of products;
calculate a drop off time for each drop off location;
calculating future temperatures of the plurality of products at a plurality of future times up to including the drop off time of the products based on the current temperatures and expected changes between the current time and the plurality of future times, the expected changes including calculating a number of door opening events before each future time; and
receiving route information; and
rearranging the route to minimise loss based on the plurality of products for which the current or future temperatures exceed the product temperature range.

Preferably the current temperature may be calculated based on information from at least one hardware temperature probe.

Alternatively, the current temperature may be calculated based on information from at least one virtual temperature probe.

Preferably the compartment may be a refrigerated unit.

Preferably the refrigerated unit may be a reefer.

Preferably the refrigerated unit has a refrigeration unit and wherein the current temperature may be calculated based on information from at least one refrigeration unit sensor.

Preferably one of the at least one refrigeration unit sensor may be a return air sensor.

Preferably the current temperature may be further calculated based on sensor information from an environment the compartment may be located in.

Preferably the sensor information on the environment the compartment may be located in includes environment temperature.

Preferably the number of door opening events may be calculated based on the route information.

Preferably a factor in calculating the future temperatures includes considering the time between drop off locations on the route.

Preferably including receiving traffic condition information and wherein calculating time between drop off locations includes considering traffic conditions.

Preferably including receiving information on the value of each of the plurality of products located in a compartment and minimising loss based on the plurality of products for which the current or future temperatures exceed the product temperature range minimising the loss based on minimising total value of the loss.

Preferably including raising an alert when current or future temperatures exceed the product temperature range with at least one of a shipper, a distributor, and a receiver of at least one of the plurality of products.

According to a further example there provided a method comprising:
obtaining a desired storage criterion for each of a plurality of products, the desired storage criteria including at least one condition, the at least one condition including a product temperature range;
receiving at a plurality of times, information on a plurality of products located in a refrigerated compartment being transported between locations, the information for each product including an identifier associated with the product; a product temperature, a current time and identifier associated with the refrigerated compartment;
storing the information;
calculating a performance score, the performance score based on product temperature range and the plurality of received product temperatures, wherein the performance score is based on other criteria including an amount of time a door of the refrigerated compartment is open during a delivery route.

Preferably including receiving information on at least one of a driver, a shipper, a distributor, a distribution centre, a receiver of the product, each associated with the product.

Preferably including receiving information on at least one of a driver and a distributor associated with the refrigerated compartment.

Preferably including collating the performance score based on at least one of a time period, the driver, the shipper, the distributor, the distribution centre, the receiver of the product.

Preferably the performance score may be based on a scoring system, the method further including the steps of:
based on the product temperature range setting for each product a plurality of temperature ranges for scoring performance;
allocating a score of zero if the product stays within a first range the entire time the product may be within the refrigerated compartment;
allocating a score of 1 if the product goes outside the first but no other range during the entire time the product may be within the refrigerated compartment; and
allocating a score of 10 if the product goes outside a second but no other range during the entire time the product may be within the refrigerated compartment.

Preferably including incrementing the score by 1 for every period of time the product goes outside the first but no other range during the entire time the product may be within the refrigerated compartment and incrementing the score by 10 for every period of time the product goes outside the second but no other range during the entire time the product may be within the refrigerated compartment.

Preferably including allocating a score of 1000 if the product goes outside a third but no other range during the entire time the product may be within the refrigerated compartment.

Preferably including incrementing the score by 1000 for every period of time the product goes outside the third but no other range during the entire time the product may be within the refrigerated compartment.

According to a still further example there is provided a product transportation scoring system comprising:
one or more processors;
memory associated with the one or more processors storing instructions to be executed by the processor; and
at least one networking device;
   wherein the processor is programmed to:
obtain a desired storage criterion for each of a plurality of products, the desired storage criteria including at least one condition, the at least one condition including a product temperature range;
receive at a plurality of times, information on a plurality of products located in a refrigerated compartment being transported between locations, the information for each product including an identifier associated with the product; a product temperature, a current time and identifier associated with the refrigerated compartment;
store the information in memory; and
calculate a performance score, the performance score based on product temperature range and the plurality of received product temperatures, wherein the performance score may be based on other criteria including an amount of time a door of the refrigerated compartment may be open during a delivery route.

Preferably the processor may be further programmed to receive information on at least one of a driver, a shipper, a distributor, a distribution centre, a receiver of the product, each associated with the product.

Preferably the processor may be further programmed to receive information on at least one of a driver and a distributor associated with the refrigerated compartment.

Preferably the processor may be further programmed to collate the performance score based on at least one of a time period, the driver, the shipper, the distributor, the distribution centre, the receiver of the product.

Preferably the performance score may be based on a scoring system, and the processor may be further programmed to:
based on the product temperature range set for each product a plurality of temperature ranges for scoring performance;
allocate a score of zero if the product stays within a first range the entire time the product may be within the refrigerated compartment;
allocate a score of 1 if the product goes outside the first but no other range during the entire time the product may be within the refrigerated compartment; and
allocate a score of 10 if the product goes outside a second but no other range during the entire time the product may be within the refrigerated compartment.

Preferably the processor may be further programmed to increment the score by 1 for every period of time the product goes outside the first but no other range during the entire time the product may be within the refrigerated compartment and increment the score by for every period of time the product goes outside the second but no other range during the entire time the product may be within the refrigerated compartment.

Preferably the processor may be further programmed to allocate a score of 1000 if the product goes outside a third but no other range during the entire time the product may be within the refrigerated compartment.

Preferably the processor may be further programmed to increment the score by 1000 for every period of time the product goes outside the third but no other range during the entire time the product may be within the refrigerated compartment.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a schematic diagram of a transport vehicle;

FIG. 2 is a graph illustrating changes in container and product temperature;

FIG. 3 is a graph illustrating changes in container and product temperature;

FIG. 4 is a graph illustrating changes in container and product temperature;

FIG. 5 is a graph illustrating changes in container and product temperature;

FIG. 6 is a graph illustrating changes in container and product temperature; and

FIG. 7 is an example dashboard of the reporting system.

### DETAILED DESCRIPTION

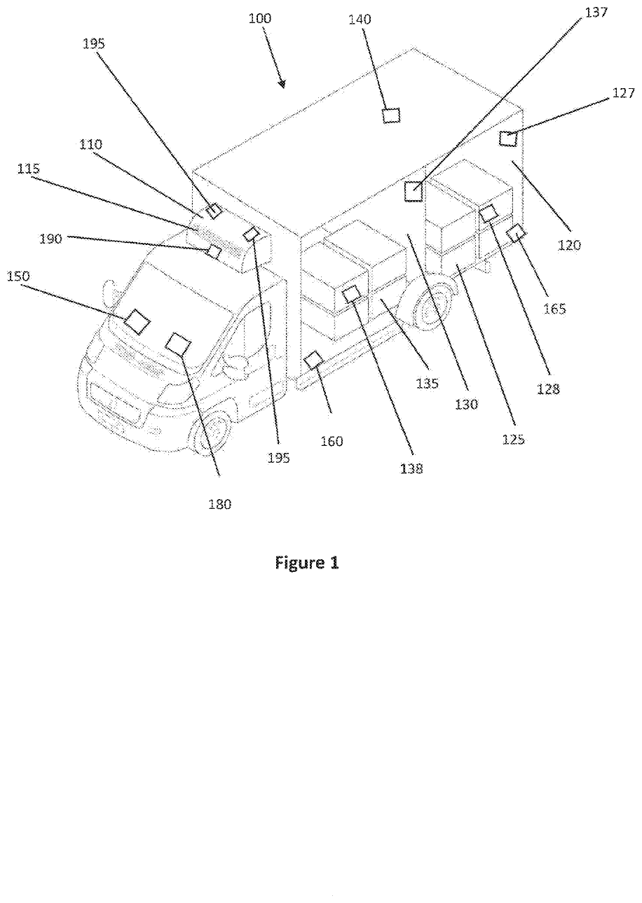

FIG. 1 is a schematic diagram of a transport vehicle according to an example embodiment. The vehicle 100 includes a number of compartments 120, 130. The compartment may be a refrigerated unit such as a reefer. The vehicle 100 also includes a refrigeration unit 110. The refrigeration unit 110 may include an inlet 115, an inlet sensor 190 and a return sensor 195 for each compartment 120, 130.

The vehicle 100 preferable has a GPS unit 180 and a system control and communication device and display 150. Further the vehicle 100 includes door monitors 160, 165. Each of the refrigerated compartments 120, 130 may include a compartment hardware temperature senor 127, 137 and hardware temperature sensors 128, 138 for the goods 125, 135 transported in the compartment.

The vehicle 100 may also include and environmental sensor 140 for monitoring outside environment conditions including temperature, wind etc.

The system in order to monitor the temperature of the goods or products 125, 135 obtains a desired storage criterion for goods that may be transported. The desired storage criteria include at least one condition but may have more conditions. The conditions including a product temperature range. The range may include a desired temperature a minimum and maximum desired temperature and the maximum time for which a product may be outside the desired temperature. The temperature range may also include minimum and maximum preferred temperatures and the maximum time for which a product may be outside the preferred temperatures. There may be multiple temperature ranges for example a first, second and third range.

Based on the product temperature range settings for each product 125, 135, one or more alert temperature ranges and or the length of time outside of a desired or preferred temperature range may be set.

In order to monitor the temperature of the goods the system 150 obtains or calculates the current temperature of each of the products 125, 135. The temperature is calculated based on a one or more of initial entered or know temperature of the products the temperature in the compartments 120, 130, the temperature of the compartment 127, 137 temperature monitors/probes, the temperature of hardware temperature sensors 128, 138 in or near some of the products.

The current temperature may be calculated based on information from the hardware temperature probes 128, 138 or may be calculated based on information from at least one virtual temperature probe.

The virtual temperature probes calculate the temperature for at least each compartment based on information from refrigeration unit 115 sensors including a return air sensor 195 for the compartment, and the inlet air sensor 190. The virtual temperature probes may further calculate the temperature based on sensor 140 information from the environment the compartment is located in.

The system 150 also calculates future temperatures of each of the products 125, 135 at a number of future times based on the current temperatures and expected changes in the compartments 120, 130 between the current time and a number of future times. The future temperatures are calculated based on the expected changes including the number of door opening events expected before the future time.

In order to estimate future door opening events the system also receives route information including the number of drop off locations on the route and the expected time between door opening events.

The system 150 may also receive traffic conditions to enable it to predict the time between drop off locations and door opening events. The future temperatures of each of the products 125, 135 can then be calculated based on a predicted time between drop off locations and door opening events.

The system 150 may raise an alert if the current or calculated future temperature exceeds a condition for any of the products 125, 135 in compartments 120, 130. Raising an alert may include alerting the driver of a vehicle transporting the compartment or raising an alert with the shippers, distributors, and/or receivers of the products 125, 135. Further even if an alert is not raised the system may display information on temperature tracking on the display 150 or a display of the shippers, distributors, and/or receivers of the products 125, 135. Further the system 150 stores this information for scoring and historical purposes.

In one embodiment the system may rearrange the route to ensure the products 125, 135 do not cause an alert or to minimise product loss based on the current or future temperatures exceeding the desired temperature range at the drop off location for the products 125, 135.

The system may further calculate a performance score for delivery of the products 125, 135, the performance score being based on product temperature range and the plurality of received product temperatures. A performance score based may be created for the driver, the distributor, and the distribution centre.

In one embodiment the performance score is based on a scoring system based on the temperature ranges.

In an example:
allocating a score of zero if the product stays within a first range the entire time the product is within the refrigerated compartment;
allocating a score of 1 if the product goes outside the first but no other range during the entire time the product is within the refrigerated compartment; and
allocating a score of 10 if the product goes outside a second but no other range during the entire time the product is within the refrigerated compartment.

The performance score may be incremented by 1 for every period of time the product goes outside the first but no other range during the entire time the product is within the refrigerated compartment and incremented by 10 for every period of time the product goes outside the second but no other range during the entire time the product is within the refrigerated compartment.

A score of 1000 may be allocated if a product goes outside a third but no other range during the entire time the product is within the refrigerated compartment. The score may further be incremented by 1000 for every period the product goes outside the third but no other range during the entire time the product is within the refrigerated compartment.

The performance score may be based on other criteria including an amount of time the door of the refrigerated compartment is open during a delivery route.

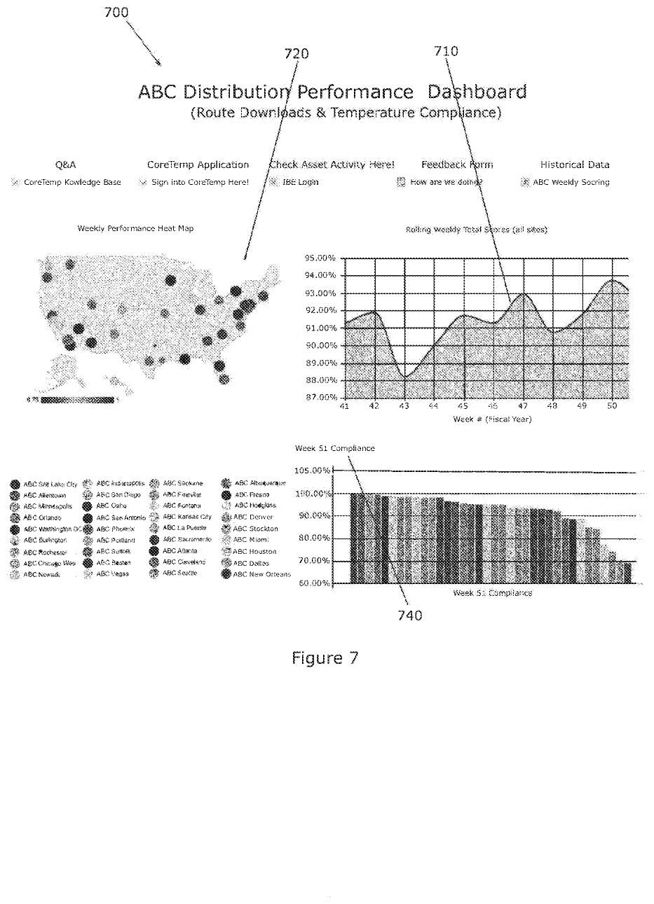

FIG. 7 illustrates if a daily delivery run for a single compartment, or route, is deemed compliant. Compliance is achieved if the virtual temperature value is within a first of two temperature ranges until the end of the last delivery on the route otherwise not compliant. A score is determined for a distribution centre as the percentage of compliant routes as compared to the total number of routes for each distribution centre. For example, suppose a distribution centre A has two routes per day, for a 30-day month, giving 60 routes delivered in the month. If in this month there were 4 non-compliant routes, then the score would be 56/60˜=93%. The purpose of the first range, in this example, is to alert the driver and distribution centre and give them the opportunity to stop the route from becoming non-compliant. The system makes the compliance score available to users via a dashboard 700 seen in FIG. 7. The dashboard may include information on Weekly Compliance 720, a rolling weekly score 710 and compliance by driver, depot or store 740.

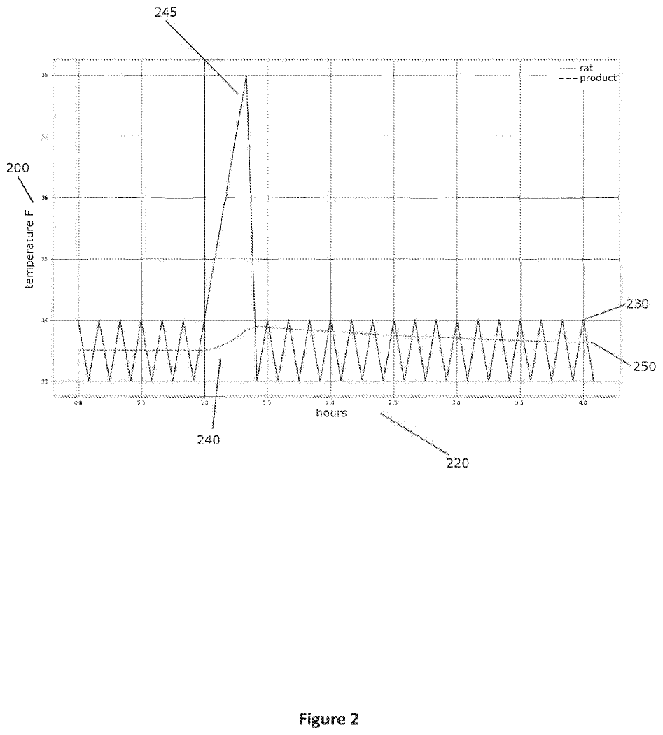

FIGS. 2 to 5 show examples of the temperature monitoring system and method. In all figure the temperature scale is on the y axis (200, 300, 400, 500) and time is on the x-axis (220, 320, 420, 520). The temperature of the storage container is as measured by the return air temperature (rat) shown by the zigzag line (230, 330, 430, 530) and the temperature of a product is shown by the smoother line (250, 350, 450, 550). A door opening event (240, 340, 440, 540) shows an immediate increase (230, 330, 430, 530) in temperature of the storage container and a slower increase in the temperature of the product. While the temperature of the storage container increases substantially and returns to the normal range quickly the temperature of the product increases only a little and the time it takes to decrease is longer than the temperature of the storage container.

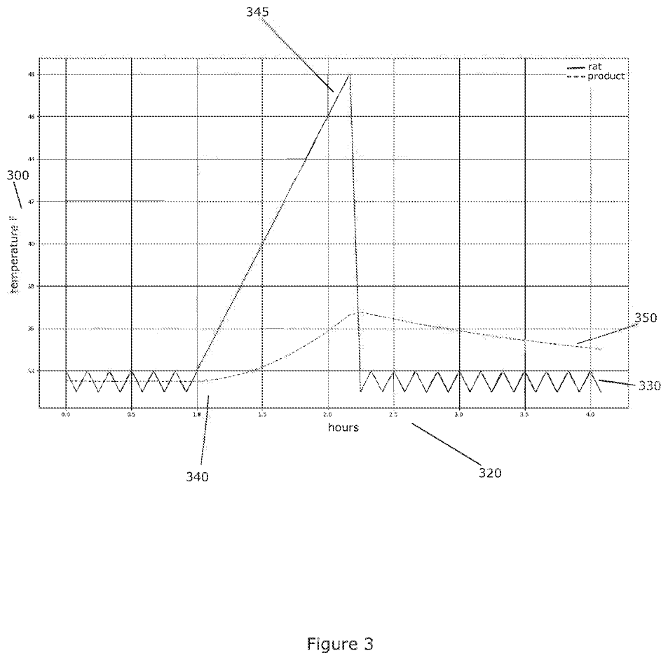

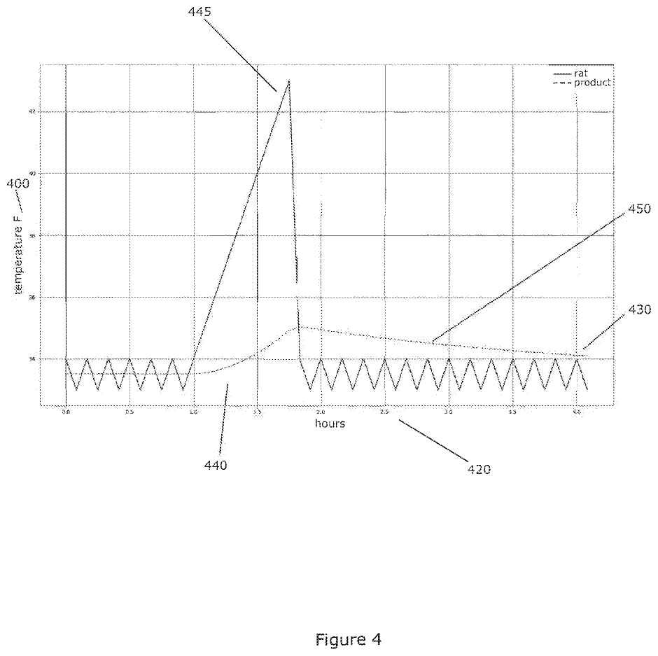

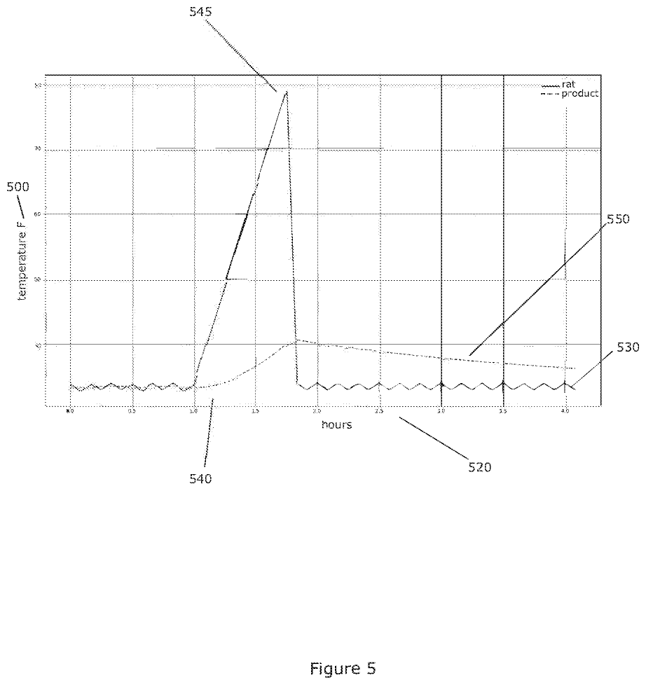

FIG. 2 shows the door being open for 20-minutes, FIG. 3 the door being open of 75 minutes, FIG. 4 the door being open of 50 minutes on a cool day and FIG. 5 the door being open of 50 minutes on a warm day. The Figures illustrate the link between the door opening time and the temperatures of the storage container and the products.

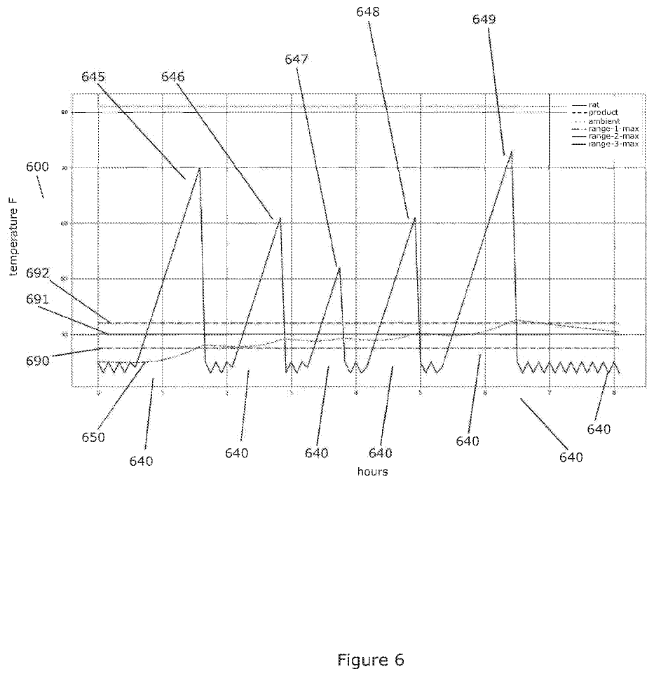

FIG. 6 shows a further example of the temperature monitoring system and method. The temperature scale is on the y axis 600 and time is on the x-axis 620. The temperature of the storage container is as measured by the return air temperature (rat) shown by the zigzag line 630 and the temperature of a product is shown by the smoother line 650. A number of door opening events 640 show an immediate increase (645, 646, 647, 648, 649) in temperature of the storage container and a slower increase in the temperature of the product. FIG. 6 also shows the maximum allowed temperature for three ranges. The bottom of each range is 33 F (close to but above freezing). The three range maximums are 37.5° (F.) 690, 40° (F.) 691 and 42° (F.) 692. There are 5 (hypothetical) events where the reefer is not actively cooling the goods, as indicated by the temperature spikes in that return air temperature 630. The third and smallest spike 647 indicates a defrost event, while the others are door open events. The ambient temperature is 81 F. After the first stop—a long one—the virtual probe temperature already exceeds range 1, 37.5° (F.) 690. It manages to stay within range 2 40° (F.) 691 for the next stop and subsequent defrost event but is still tending upwards. After the third stop it has exceeded the second range, and after the last stop it has exceeded the third range. The product is quite possibly spoiled having exceeded the third range.

It is clear from these plots that the reefer is simply off for too much of the trip and is not keeping the load at temperature on this warm day (ambient temperature 81 F 81). The plot visualization with virtual temperature may makes it clear what the problem is. The plot visualization may be displayed on the display 150 or on temperature tracking on the display 150 or a display of the shippers, distributors, and/or receivers of the products 125, 135.

The system and dashboard 700 can also be used to allow messaging between shipper and distributors about actions regarding a route and allow electronic settlement of breaches. Further the dashboard 700 can be used to provide reporting on shipper expectations (e.g. daily store delivery count) versus distributor actual achievement, provide methods to meet compliance requirements when equipment is faulty or if rental vehicles are used, implement FSMA requirement checking, extend to track incoming deliveries to distributor sites and integrate with other mobile workflow solutions for routing. The dashboard 700 may be accessed by the various parties remotely from example via an application, a mobile app or a web site.

Additional functionality includes holding user information such that inbound delivery ETA and temp info can be presented continuously. Collect route/delivery feedback at store and allow product comments to be entered for the route instance, provide oversight and scheduling capabilities of products, assets (vehicles), locations and routes.

The system provides variable scoped, real-time analytics on managed routes, including:
route status;
route compliance;
temperature compliance;
asset (vehicle) coverage; and
asset (vehicle) management.

### Interpretation

A number of methods have been described above. It will be appreciated that any of these methods may be embodied by a series of instructions, which may form a computer program. These instructions, or this computer program, may be stored on a computer readable medium, which may be non-transitory. When executed, these instructions or this program may cause a processor, such as a CPU or GPU, to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The order of steps within methods may be altered, such that steps are performed out of order or in parallel, except where one step is dependent on another having been performed, or the context otherwise requires.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method comprising:
obtaining a desired storage criterion for each of a plurality of products, the desired storage criteria including at least one condition, the at least one condition including a product temperature range;
based on the product temperature range setting for each product at least one alert temperature range;
calculating a current temperature of each of the plurality of products located in a compartment at a current time, the compartment including at least one door;
calculating future temperatures of each of the plurality of products at a plurality of future times based on the current temperatures and expected changes between the current time and the plurality of future times, the expected changes including calculating a number of door opening events before the future time.

2. The method of claim 1, wherein the compartment is being transported between locations and the method includes receiving route information and wherein the number of door opening events is based on the route information.

3. The method of claim 2, wherein a factor in calculating the future temperatures includes considering the time between drop off locations on the route.

4. The method of claim 3, wherein calculating time between drop off locations includes considering traffic conditions and the method includes receiving traffic condition information.

5. The method of claim 1, wherein the current temperature is calculated based on information from at least one hardware temperature probe and/or at least one virtual temperature probe.

6. (canceled)

7. The method of claim 1, wherein the compartment is a refrigerated unit.

8. (canceled)

9. The method of claim 7, wherein the refrigerated unit has a refrigeration unit and wherein the current temperature is calculated based on information from at least one refrigeration unit sensor.

10. The method of claim 9, wherein one of the at least one refrigeration unit sensor is a return air sensor.

11. The method of claim 9, wherein the current temperature is further calculated based on sensor information from an environment the compartment is located in.

12. (canceled)

13. The method of claim 11, further comprising for each of the plurality of products raising an alert if the current or calculated future temperature exceeds the product temperature range for that product.

14. (canceled)

15. (canceled)

16. A product storage criterion system comprising:
one or more processors;
memory associated with the one or more processors storing instructions to be executed by the processor; and
at least one networking device;
wherein the one or more processors is programmed to:
obtaining a desired storage criterion for each of a plurality of products, the desired storage criteria including at least one condition, the at least one condition including a product temperature range;
based on the product temperature range setting for each product at least one alert temperature range;
calculate a current temperature of each of the plurality of products located in a compartment at a current time, the compartment including at least one door;
calculate future temperatures of each of the plurality of products at a plurality of future times based on the current temperatures and expected changes between the current time and the plurality of future times, the expected changes including calculating a number of door opening events before the future time.

17. The system of claim 16, wherein the compartment is being transported between locations and the system includes receiving route information via the networking device and wherein the number of door opening events is based on the route information.

18. The system of claim 17, wherein a factor in calculating the future temperatures includes considering the time between drop off locations on the route.

19. The system of claim 18, wherein calculating time between drop off locations includes considering traffic conditions and the system includes receiving traffic condition information via the networking device.

20. The system of claim 16, wherein the system includes at least one hardware temperature probe and the current temperature is calculated by the one or more processors based on information from the at least one hardware temperature probe and/or at least one virtual temperature probe.

21. (canceled)

22. The system of claim 16, wherein the compartment is a refrigerated unit.

23. (canceled)

24. The system of claim 22, wherein the refrigerated unit has a refrigeration unit including at least one refrigeration unit sensor in communication with the one or more processors and wherein the current temperature is calculated by the one or more processors based on information from at least one refrigeration unit sensor.

25. The system of claim 24, wherein one of the at least one refrigeration unit sensor is a return air sensor.

26. The system of claim 24, wherein system the current temperature is further calculated by the one or more processors based on sensor information received by the processor from an environment the compartment is located in.

27. (canceled)

28. The system of claim 26, wherein the one or more processors further programmed to for each of the plurality of products raising an alert if the current or calculated future temperature exceeds the product temperature range for that product.

29-74. (canceled)
